(19) United States
(12) Patent Application Publication
(10) Pub. No.: US 2025/0107573 A1
(43) Pub. Date: Apr. 3, 2025

(54) AEROSOL GENERATING DEVICE AND METHOD OF MANUFACTURING OUTER COVER FOR AEROSOL GENERATING DEVICE

(71) Applicant: KT & G CORPORATION, Daejeon (KR)

(72) Inventors: Dong Sung KIM, Seoul (KR); Hun Il LIM, Seoul (KR); Young Bum KWON, Yongin-si, Gyeonggi-do (KR); Yong Hwan KIM, Anyang-si, Gyeonggi-do (KR)

(73) Assignee: KT & G CORPORATION, Daejeon (KR)

(21) Appl. No.: 18/289,949

(22) PCT Filed: Aug. 11, 2023
(86) PCT No.: PCT/KR2023/012000

§ 371 Date: Nov. 8, 2023

(30) Foreign Application Priority Data
Aug. 30, 2022 (KR) 10-2022-0109488
Nov. 18, 2022 (KR) 10-2022-0155399

(51) Int. Cl. A24F 40/70; A24F 40/10; A24F 40/20; A24F 40/30; A24F 40/465; A24F 40/51; A24F 40/60; F21V 9/08; F21V 13/10; F21Y 105/12

(52) U.S. Cl. CPC A24F 40/70; F21V 9/083; F21V 13/10; A24F 40/10; A24F 40/20; A24F 40/30; A24F 40/465; A24F 40/51; A24F 40/60; F21Y 2105/12

(57) ABSTRACT

An aerosol generating device includes a main body and an outer cover coupled to the main body, wherein the outer cover includes a circuit layer, a base layer, a light-transmitting layer, a shielding layer, and a coating layer, which are sequentially arranged in a direction from a rear surface of the outer cover toward a front surface of the outer cover, and one or more light-emitting units arranged on the circuit layer, the base layer, the light-transmitting layer, the shielding layer, and the coating layer include a material capable of transmitting light, and light emitted from the light-emitting units sequentially passes through the base layer, the light-transmitting layer, the shielding layer, and the coating layer.

### TECHNICAL FIELD

The disclosure relates to an aerosol generating device and a method of manufacturing an outer cover for an aerosol generating device, and more particularly, to an aerosol generating device including an outer cover capable of improving the overall aesthetics of the aerosol generating device while ensuring the uniformity of light emitted to the outside by reducing positional deviation between a light source and the outer cover and preventing a bole for transmitting light from being visible from the outside.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes.

As functions of aerosol generating devices become increasingly diversified, various notification functions have been added. In particular, a plurality of light-emitting units may be arranged to precisely express the number of puffs or the remaining battery capacity. As the number of light-emitting units arranged in an aerosol generating device increases, aesthetics have deteriorated due to an increase in components for display of the light-emitting units or tolerance between the components.

### DISCLOSURE OF INVENTION

### Technical Problem

Various embodiments improve the overall aesthetics of an aerosol generating device while securing the uniformity of light emitted to the outside, by preventing a hole for transmitting light emitted from a light-emitting unit and for displaying the light on an outer cover from being visible from the outside.

The problems to be solved by embodiments are not limited to the problems described above, and problems not mentioned may be clearly understood by one of ordinary skill in the art to which the embodiments belong from the description and the accompanying drawings.

### Solution to Problem

According to an aspect of the disclosure, an aerosol generating device includes a main body and an outer cover coupled to the main body, wherein the outer cover includes a circuit layer, a base layer, a light-transmitting layer, a shielding layer, and a coating layer, which are sequentially arranged in a direction from a rear surface of the outer cover toward a front surface of the outer cover, and one or more light-emitting units arranged on the circuit layer, the base layer, the light-transmitting layer, the shielding layer, and the coating layer include a material capable of transmitting light, and light emitted from the light-emitting unit sequentially passes through the base layer, the light-transmitting layer, the shielding layer, and the coating layer.

According to another aspect of the disclosure, a method of manufacturing an outer cover for an aerosol generating device includes providing a base layer, sequentially stacking a light-transmitting layer, a shielding layer, and a coating layer on a front surface of the base layer, and arranging, on a rear surface of the base layer, a circuit layer on which one or more light-emitting units are arranged, wherein the base layer, the light-transmitting layer, the shielding layer, and the coating layer include a material capable of transmitting light, and light emitted from the light-emitting units sequentially passes through the base layer, the light-transmitting layer, the shielding layer, and the coating layer.

The means for solving the problems is not limited to the above description, and may include all of the matters that may be inferred by one of ordinary skill in the art throughout the description.

### Advantageous Effects of Invention

An aerosol generating device according to an embodiment may, while using a plurality of light sources, provide a structure that efficiently uses the light sources and does not impair the overall aesthetics of the aerosol generating device.

Effects of the present disclosure are not limited to the above effects, and effects that are not mentioned could be clearly understood by one of ordinary skill in the art from the present specification and the attached drawings.

### BRIEF DESCRIPTION OF DRAWINGS

FIGS. 1 and 3 are diagrams showing examples in which a cigarette is inserted into an aerosol generating device, in accordance with embodiments.

FIGS. 4 and 5 are diagrams showing examples of cigarettes.

FIG. 6A is a view illustrating the external appearance of an aerosol generating device according to an embodiment.

FIG. 6B schematically illustrates a position at which a circuit layer is attached to an outer cover of an aerosol generating device, according to an embodiment.

FIGS. 7 to 12 are schematic cross-sectional views of an outer cover of an aerosol generating device, according to different embodiments.

FIG. 13 is a block diagram of an aerosol generating device according to an embodiment.

### MODE FOR THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, hen an expression such as “at least any one” precedes arranged elements, it modifies all elements rather than each arranged element. For example, the expression “at least any one of a, b, and e” should be construed to include a, b, c, or a and b, a and c, b and c, or a, b, and c.

Further, as used herein, the terms including ordinal numbers like “first” and “second” may be used to explain various components, but the components are not limited by the terms. The terms are only for the purpose of distinguishing a component from another.

As used herein, the term ‘aerosol generating device’ may refer to a device that generate an aerosol using an aerosol generating substrate in order to generate an aerosol that is directly inhalable into a user's lungs thorough the user's mouth.

As used herein, the term “cigarette” an article used for smoking. For example, a cigarette may be a combustible cigarette used in a manner that is ignited and burned, or may be a heated cigarette used in a manner heated by an aerosol generating device.

Hereinafter, the present disclosure will now be described more fully with reference to the accompanying drawings, in which exemplary embodiments of the present disclosure are shown such that one of ordinary skill in the art may easily work the present disclosure. However, the present disclosure may be implemented in various different forms, and is not limited to the embodiments described herein.

Hereinafter, embodiments of the present disclosure will be described in detail with reference to the drawings.

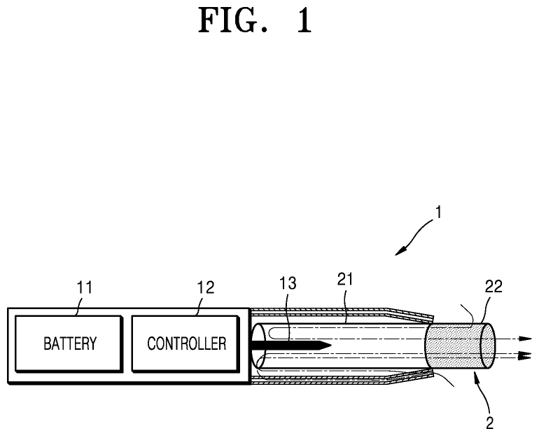

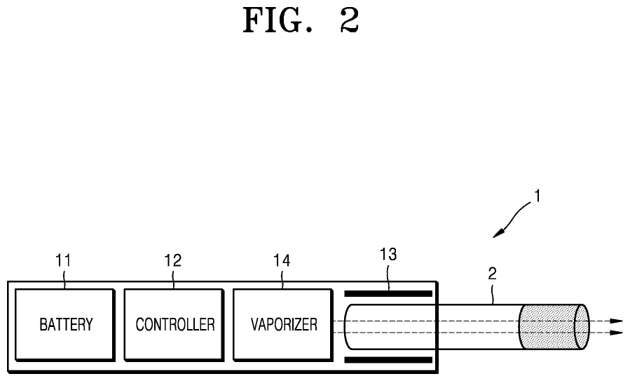

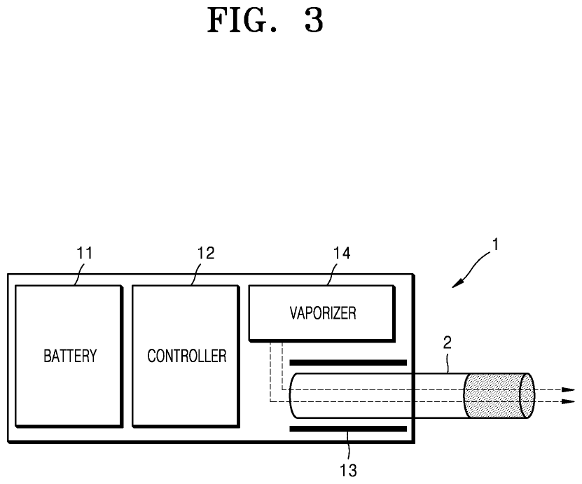

FIGS. 1 and 3 are diagrams showing examples in which a cigarette is inserted into an aerosol generating device, in accordance with embodiments.

Referring to FIG. 1, the aerosol generating device 1 may include a battery 11, a controller 12, and a beater 13. Referring to FIGS. 2 and 3, the aerosol generating device 1 may further include a vaporizer 14. Also, the cigarette 2 may be inserted into an inner space of the aerosol generating device 1.

FIGS. 1 to 3 illustrates components of the aerosol generating device 1, which are related to the present embodiment. Therefore, it will be understood by one of ordinary skill in the art related to the present embodiment that other general-purpose components may be further included in the aerosol generating device 1, in addition to the components illustrated in FIGS. 1 to 3.

Also, FIGS. 2 and 3 illustrate that the aerosol generating device 1 includes the heater 13. However, as necessary, the heater 13 may be omitted.

FIG. 1 illustrates that the battery 11, the controller 12, and the heater 13 are arranged in series. Also, FIG. 2 illustrates that the battery 11, the controller 12, the vaporizer 14 and the heater 13 are arranged in series. Also, FIG. 3 illustrates that the vaporizer 14 and the heater 13 are arranged in parallel. However, the internal structure of the aerosol generating device 1 is not limited to the structures illustrated in FIGS. 1 to 3. In other words, according to the design of the aerosol generating device 1, the battery 11, the controller 12, the heater 13, and the vaporizer 14 may be differently arranged.

When the cigarette 2 is inserted into the aerosol generating device 1, the aerosol generating device 1 may operate the vaporizer 14 to generate aerosol from the vaporizer 14. The aerosol generated by the heater 13 and/or the vaporizer 14 is delivered to a user by passing through the cigarette 2.

In some cases, the aerosol generating apparatus 1 may operate the heater 13 even when the cigarette 2 is not inserted into the aerosol generating apparatus 1.

The battery 11 may supply power to be used for the aerosol generating device 1 to operate. For example, the battery 11 may supply power to heat the heater 13 or the vaporizer 14, and may supply power for operating the controller 12. Also, the battery 11 may supply power for operations of a display, a sensor, a motor, etc. mounted in the aerosol generating device 1.

The controller 12 may generally control operations of the aerosol generating device 1. In detail, the controller 12 may control not only operations of the battery 11, the heater 13, and the vaporizer 14, but also operations of other components included in the aerosol generating device 1. Also, the controller 12 may check a state of each of the components of the aerosol generating device 1 to determine whether or not the aerosol generating device 1 is able to operate.

The controller 12 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The heater 13 may be heated by the power supplied from the battery 11. For example, when the cigarette is inserted into the aerosol generating device 1, the heater 13 may be located outside the cigarette 2. Thus, the heated heater 13 may increase a temperature of an aerosol generating material in the cigarette.

The heater 13 may include an electro-resistive beater. For example, the heater 13 may include an electrically conductive track, and the heater 13 may be heated when currents flow through the electrically conductive track. However, the heater 13 is not limited to the example described above and may include all heaters which may be heated to a desired temperature. Here, the desired temperature may be pre-set in the aerosol generating device 1 or may be set by a user.

As another example, the heater 13 may include an induction heater. In detail, the heater 13 may include an electrically conductive coil for heating a cigarette 2 in an induction beating method, and the aerosol generating article may include a susceptor which may be heated by the induction heater.

For example, the heater 13 may include a tube-type heating element, a plate-type heating element, a needle-type heating element, or a rod-type heating element, and may heat the inside or the outside of the cigarette 2, according to the shape of the heating element.

Also, the aerosol generating device 1 may include a plurality of heaters 13. Here, the plurality of heaters 13 may be inserted into the cigarette 2 or may be arranged outside the cigarette 2. Also, some of the plurality of heaters 13 may be inserted into the cigarette 2 and the others may be arranged outside the cigarette 2. In addition, the shape of the heater 13 is not limited to the shapes illustrated in FIGS. 1 to 3 and may include various shapes.

The vaporizer 14 may generate aerosol by heating a liquid composition and the generated aerosol may pass through the cigarette 2 to be delivered to a user. In other words, the aerosol generated via the vaporizer 14 may move along an air flow passage of the aerosol generating device 1 and the air flow passage may be configured such that the aerosol generated via the vaporizer 14 passes through the cigarette 2 to be delivered to the user.

For example, the vaporizer 14 may include a liquid storage, a liquid delivery element, and a heating element, but it is not limited thereto. For example, the liquid storage, the liquid delivery element, and the heating element may be included in the aerosol generating device 1 as independent modules.

The liquid storage may store a liquid composition. For example, the liquid composition may be a liquid including a tobacco-containing material having a volatile tobacco flavor component, or a liquid including a non-tobacco material. The liquid storage may be formed to be detachable from the vaporizer 14 or may be formed integrally with the vaporizer 14.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal beating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 14 may be referred to as a cartomizer or an atomizer, but it is not limited thereto.

The aerosol generating device 1 may further include general-purpose components in addition to the battery 11, the controller 12, the heater 13, and the vaporizer 14. For example, the aerosol generating device 1 may include a display capable of outputting visual information and/or a motor for outputting haptic information. Also, the aerosol generating device 1 may include at least one sensor (a puff sensor, a temperature sensor, an aerosol generating article insertion detecting sensor, etc.). Also, the aerosol generating device 1 may be formed as a structure that, even when the cigarette 2 is inserted into the aerosol generating device 100, may introduce external air or discharge internal air.

Although not illustrated in FIGS. 1 to 3, the aerosol generating device 1 and an additional cradle may form together a system. For example, the cradle may be used to charge the battery 11 of the aerosol generating device 1. Alternatively, the heater 13 may be heated when the cradle and the aerosol generating device 1 are coupled to each other.

The cigarette 2 may be similar to a general combustive cigarette. For example, the cigarette 2 may be divided into a first portion including an aerosol generating material and a second portion including a filter, etc. Alternatively, the second portion of the cigarette 2 may also include an aerosol generating material. For example, an aerosol generating material made in the form of granules or capsules may be inserted into the second portion.

The entire first portion may be inserted into the aerosol generating device 1, and the second portion may be exposed to the outside. Alternatively, only a portion of the first portion may be inserted into the aerosol generating device 100, or the entire first portion and a portion of the second portion may be inserted into the aerosol generating device 1. The user may puff aerosol while holding the second portion by the mouth of the user. In this case, the aerosol is generated by the external air passing through the first portion, and the generated aerosol passes through the second portion and is delivered to the user's mouth.

For example, the external air may flow into at least one air passage formed in the aerosol generating device 1. For example, opening and closing of the air passage and/or a size of the air passage formed in the aerosol generating device 1 may be adjusted by the user. Accordingly, the amount and the quality of smoking may be adjusted by the user. As another example, the external air may flow into the cigarette 2 through at least one hole formed in a surface of the cigarette 2.

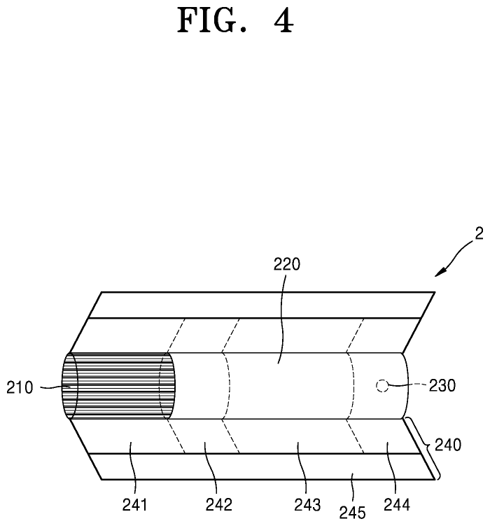

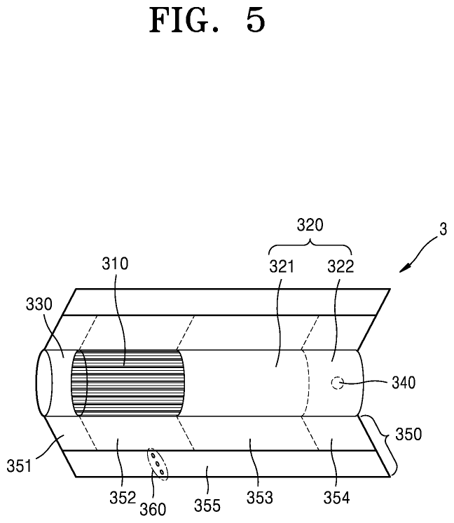

Examples of the cigarette 2 are described below with reference to FIGS. 4 and 5.

FIGS. 4 and 5 show examples of cigarettes.

Referring to FIG. 4, the cigarette 2 may include a tobacco rod 210 and a filter rod 220. The first portion described above with reference to FIGS. 1 to 3 may include the tobacco rod 210, and the second portion may include the filter rod 220.

FIG. 4 illustrates that the filter rod 220 includes a single segment. However, the filter rod 220 is not limited thereto. In other words, the filter rod 220 may include a plurality of segments. For example, the filter rod 220 may include a segment configured to cool an aerosol and a segment configured to filter a certain component included in the aerosol. Also, as necessary, the filter rod 220 may further include at least one segment configured to perform other functions.

The cigarette 2 may have a diameter in the range of 5 mm to 9 mm and a length of about 48 mm, but is not limited to. For example, the length of the tobacco rod 210 may be about 12 mm, the length of the first segment of the filter rod 220 may be about 10 mm, the length of the second segment of the filter rod 220 may be about 14 mm long, and the length of the third segment of the filter rod 220 may be about 12 mm, but is not limited to.

The cigarette 2 may be packaged using at least one wrapper 240. The wrapper 240 may have at least one hole through which external air may be introduced or internal air may be discharged. For example, the cigarette 2 may be packaged by one wrapper 240. As another example, the cigarette 2 may be doubly packaged by two or more wrappers 240. For example, the tobacco rod 210 may be packaged by a first wrapper 241, and the filter rod 220 may be packaged by wrappers 242, 243, and 244. Also, the entire cigarette 2 may be re-packaged by a single wrapper. When the filter rod 220 includes a plurality of segments, each segment may be packaged by wrappers 242, 243, and 244.

The first wrapper 241 and the second wrapper 242 may be made of general filter paper. For example, the first wrapper 241 and the second wrapper 242 may be porous paper or non-porous paper. Also, the first wrapper 241 and the second wrapper 242 may be made of paper oil-resistant paper and/or aluminum laminated wrapping paper.

The third wrapper 243 may be made of hard paper. For example, the basis weight of the third wrapper 243 may be included in the range of 88 g/m² to 96 g/m², and preferably in the range of 90 g/m² to 94 g/m². In addition, the thickness of the third wrapper 243 may be included in the range of 120 μm to 130 μm, and preferably 125 μm.

The fourth wrapper 244 may be made of oil-resistant hard paper. For example, the basis weight of the fourth wrapper 244 may be included in the range of 88 g/m² to 96 g/m², and preferably in the range of 90 g/m² to 94 g/m². In addition, the thickness of the fourth wrapper 244 may be included in the range of 120 μm to 130 μm, and preferably 125 μm.

The fifth wrapper 245 may be made of sterile paper (MFW). Here, the sterile paper (MFW) refers to paper that is specially manufactured to improve tensile strength, water resistance, smoothness, and the like compared to general paper. For example, a basis weight of the fifth wrapper 245 may be included in a range of 57 g/m² to 63 g/m², and preferably 60 g/m². In addition, a thickness of the fifth wrapper 245 may be included in a range of 64 μm to 70 μm, and preferably 67 μm.

A predetermined material may be added to the fifth wrapper 245. Here, an example of the predetermined material may be silicon, but is not limited thereto. For example, silicon has properties such as heat resistance with little change with temperature, oxidation resistance that does not oxidize, resistance to various chemicals, water repellency, or electrical insulation. However, any material having the properties described above may be applied (or coated) to the fifth wrapper 245 without limitation, even if not silicone.

The fifth wrapper 245 may prevent the cigarette 2 from burning. For example, when the tobacco rod 21 is heated by the heater 13, there is a possibility that the cigarette 2 may be burned. Specifically, the cigarette 2 may combust when the temperature is raised above the ignition point of any of the materials contained in the tobacco rod 310. Even in this case, the combustion of the cigarette 2 may be prevented because the fifth wrapper 245 comprise a non-combustible material.

In addition, the fifth wrapper 245 may prevent the holder from being contaminated by substances generated by the cigarette 2. Liquid substances may be generated in the cigarette 2 by the user's puff. For example, as the aerosol generated by the cigarette 2 is cooled by external air, liquid substances (e.g., moisture, etc.) may be generated. As the fifth wrapper 245 wraps the cigarette 2, liquid substances generated within the cigarette 2 may be prevented from leaking out of the cigarette 2.

The tobacco rod 210 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 210 may include other additives, such as flavors, a wetting agent, and/or organic acid. Also, the tobacco rod 210 may include a flavored liquid, such as menthol or a moisturizer, which is injected to the tobacco rod 210.

The tobacco rod 210 may be manufactured in various forms. For example, the tobacco rod 210 may be formed as a sheet or a strand. Also, the tobacco rod 210 may be formed as a pipe tobacco, which is formed of tiny bits cut from a tobacco sheet. Also, the tobacco rod 210 may be surrounded by a heat conductive material. For example, the heat conductive material may be, but is not limited to, a metal foil such as aluminum foil. For example, the heat conductive material surrounding the tobacco rod 210 may uniformly distribute heat transmitted to the tobacco rod 210, and thus, the heat conductivity applied to the tobacco rod may be increased and taste of the tobacco may be improved. Also, the heat conductive material surrounding the tobacco rod 210 may function as a susceptor heated by the induction heater. Here, although not illustrated in the drawings, the tobacco rod 210 may further include an additional susceptor, in addition to the heat conductive material surrounding the tobacco rod 210.

The filter rod 220 may include a cellulose acetate filter. Shapes of the filter rod 220 are not limited. For example, the filter rod 220 may include a cylinder-type rod or a tube-type rod having a hollow inside. Also, the filter rod 220 may include a recess-type rod. If the filter rod 220 is composed of a plurality of segments, at least one of the plurality of segments may be manufactured in a different shape.

The first segment of the filter rod 220 may be cellulose acetate filter. For example, the first segment may be tube-shaped structure including a hollow formed therein. When the heater 13 is inserted by the first segment, it may prevent the internal material of the tobacco rod 210 from being pushed back, and a cooling effect of the aerosol may also occur. A diameter of the hollow included in the first segment may be appropriately selected within a range of 2 mm to 4.5 mm but is not limited thereto.

A length of the first segment may be appropriately selected within a range of 4 mm to 30 mm but is not limited thereto. Preferably, a length of the first segment may be 10 mm, but is not limited thereto.

The hardness of the first segment may be adjusted by adjusting the content of the plasticizer when the first segment is manufactured. Also, the first segment may be manufactured by inserting a structure such as a film or tube made of the same or a different material into the inside (e.g., hollow).

The second segment of filter rod 220 cools the aerosol generated by the heater 13 heating the tobacco rod 210. Thus, a user may inhale the aerosol cooled to an appropriate temperature.

The length or diameter of the second segment may be variously determined according to the shape of the cigarette 2. For example, the length of the second segment may have an appropriate length within the range of 7 mm to 20 mm. Preferably, the length of the second segment may about 14 mm, but is not limited thereto.

The second segment may be fabricated by weaving polymer fibers. In this case, flavoring liquid may be applied to fibers made of polymer. Alternatively, the second segment may be manufactured by weaving together separate fibers applied with a flavoring liquid and fibers made of a polymer. Alternatively, the second segment may be formed by a crimped polymer sheet.

For example, the polymer may be made of a material selected from the group consisting of polyethylene (PE), polypropylene (PP), polyvinyl chloride (PVC), polyethylene terephthalate (PET), poly lactic acid (PLA), cellulose acetate (CA), and aluminum foil.

As the second segment is formed by woven polymer fibers or crimped polymer sheets, the second segment may comprise a single or plurality of channels extending longitudinally. Here, a channel means a passage through which gas (e.g., air or aerosol) passes.

For example, the second segment of the crimped polymer sheet may be formed from a material having a thickness between about 5 μm and about 300 μm, such as between about 10 μm and about 250 μm. Also, the total surface area of the second segment may be between about 300 mm²/mm and about 1000 mm²/mm. Also, the aerosol cooling element may be formed from a material having a specific surface area between about 10 mm²/mg and about 100 mm²/mg.

Meanwhile, the second segment may include a thread containing a volatile flavor component. Here, the volatile flavor component may be menthol, but is not limited thereto. For example, the thread may be loaded with sufficient menthol to provide at least 1.5 mg of menthol to the second segment.

The third segment of filter rod 220 may be a cellulose acetate filter. The length of the third segment may be appropriately selected within the range of 4 mm to 20 mm. For example, the length of the third segment may be 12 mm, but is not limited thereto.

In the process of manufacturing the third segment, flavor may be generated by spraying flavoring liquid on the third segment. Alternatively, a separate fiber coated with the flavoring liquid may be inserted into the third segment. The generated aerosol in the tobacco rod 210 is cooled as it passes through the second segment of the filter rod 220, and the cooled aerosol is delivered to the user through the third segment. Therefore, when a flavoring element is added to the third segment, the effect of enhancing the persistence of the flavor delivered to the user may occur.

Also, the filter rod 220 may include at least one capsule 230. Here, the capsule 230 may generate a flavor or an aerosol. For example, the capsule 230 may have a configuration in which a liquid containing a flavoring material is wrapped with a film. For example, the capsule 230 may have a spherical or cylindrical shape, but is not limited thereto.

Referring to FIG. 5, the cigarette 3 may further include a front-end plug 330. The front-end plug 330 may be located on one side of the tobacco rod 31 which is opposite to the filter rod 32. The front-end plug 330 may prevent the tobacco rod 310 from being detached outwards and prevent a liquefied aerosol from flowing into the aerosol generating device 1 (FIGS. 1 through 3) from the tobacco rod 310, during smoking.

The filter rod 320 may include a first segment 321 and second segment 322. Here, the first segment 321 can correspond to a first segment of a filter rod 220 of FIG. 4, and the second segment 322 can correspond to a third segment of a filter rod 220 of FIG. 4.

The diameter and total length of the cigarette 3 can correspond to the diameter and total length of the cigarette 2 of FIG. 4. For example, the length of the front-end plug 330 may be about 7 mm, the length of the tobacco rod 31 may be about 15 mm, the length of the first segment 321 may be about 12 mm, and the length of the second segment 322 may be about 14 mm, but it is not limited to this.

The cigarette 3 may be packaged via at least one wrapper 350. The wrapper 350 may have at least one hole through which external air may be introduced or internal air may be discharged. For example, the front-end plug 330 may be packaged via a first wrapper 351, and the tobacco rod 310 may be packaged via a second wrapper 352, and the first segment 321 may be packaged via a third wrapper 353, and the second segment 322 may be packaged via a fourth wrapper 354. Also, the entire cigarette 3 may be packaged via a fifth wrapper 355.

Also, the fifth wrapper 355 may have at least one hole 36. For example, the hole 36 may be formed in an area surrounding the tobacco rod 31, but is not limited thereto. The hole 36 may serve to transfer heat formed by the heater 13 shown in FIG. 2 and FIG. 3 to the inside of the tobacco rod 310.

Also, the second segment 322 may include at least one capsule 340. Here, the capsule 340 may generate a flavor or an aerosol. For example, the capsule 340 may have a configuration in which a liquid containing a flavoring material is wrapped with a film. For example, the capsule 340 may have a spherical or cylindrical shape, but is not limited thereto.

In addition, the first wrapper 351 may be made by coupling a metal foil such as an aluminum foil to general filter wrapping paper. For example, a total thickness of the first wrapper 351 may be included in a range of 44 um to 55 um and preferably 50.3 μm. In addition, a thickness of the metal foil of the first wrapper 351 may be included in a range of 6 um to 7 um, and preferably 6.3 um. In addition, a basis weight of the first wrapper 351 may be included in a range of 50 g/m² to 55 g/m², and preferably 53 g/m².

The second wrapper 352 and the third wrapper 353 may be made of general filter paper. For example, the second wrapper 352 and the third wrapper 353 may be porous paper or non-porous paper.

For example, porosity of the second wrapper 352 may be 35000 CU but is not limited thereto. In addition, a thickness of the second wrapper 352 may be included in a range of 70 um to 80 um, and preferably 78 um. In addition, a basis weight of the second wrapper 352 may be included in a range of 20 g/m² to 25 g/m², and preferably 23.5 g/m².

For example, porosity of the third wrapper 353 may be 24000 CU but is not limited thereto. In addition, a thickness of the third wrapper 353 may be included in a range of 60 um to 70 um, and preferably 68. In addition, a basis weight of the third wrapper 353 may be included in a range of 20 g/m² to 25 g/m², and preferably 21 g/m².

The fourth wrapper 354 may be made of PLA laminated paper. Here, the PLA laminated paper means three-layer paper including a paper layer, a PLA layer and a paper layer. For example, a thickness of the fourth wrapper 354 may be included in a range of 100 um to 120 um, and preferably 110 um. In addition, a basis weight of the fourth wrapper 354 may be included in a range of 80 g/m² to 100 g/m², and preferably 88 g/m² um.

The fifth wrapper 355 may be made of sterile paper (MFW). For example, a basis weight of the fifth wrapper 245 may be included in a range of 57 g/m² to 63 g/m², and preferably 60 g/m². In addition, a thickness of the fifth wrapper 245 may be included in a range of 64 um to 70 um, and preferably 67 um.

The front plug 330 may be made of cellulose acetate. For example, the front plug 330 may be made by adding a plasticizer (for example, triacetin) to cellulose acetate tow. The mono denier of filaments comprising cellulose acetate tow may be included within a range of 1.0 to 10.0, and preferably within a range of 4.0 to 6.0. More preferably, the mono denier of filaments of the front plug 330 may be 5.0. Additionally, the cross-section of the filaments comprising the front plug 330 may be Y-shaped. The total denier of the front plug 330 may be in the range of 20,000 to 30,000, and preferably in the range of 25,000 to 30,000. More preferably, the total denier of the front plug 330 may be 28,000.

Also, if necessary, the front plug 330 may include at least one channel, and the cross-sectional shape of the channel may be manufactured in various ways.

The tobacco rod 310 may correspond to the tobacco rod 210 described above with reference to FIG. 4. Accordingly, the specific description of the tobacco rod 310 is omitted herein.

The first segment 321 may be made of cellulose acetate. For example, the first segment 321 may be tube-shaped structure including a hollow formed therein. The first segment 321 may be made by adding a plasticizer (for example, triacetin) to cellulose acetate tow. For example, the mono denier and total denier of the first segment 321 may be the same as the mono denier and total denier of the front plug 330.

The second segment 322 may be made of cellulose acetate. The mono denier of filaments comprising the second segment 322 may be included within a range of 1.0 to 10.0, and preferably within a range of 8.0 to 10.0. More preferably, the mono denier of filaments of the second segment 322 may be 9.0. Additionally, the cross-section of the filaments of the second segment 322 may be Y-shaped. The total denier of the second segment 322 may be in the range of 20,000 to 30,000, and preferably 25,000.

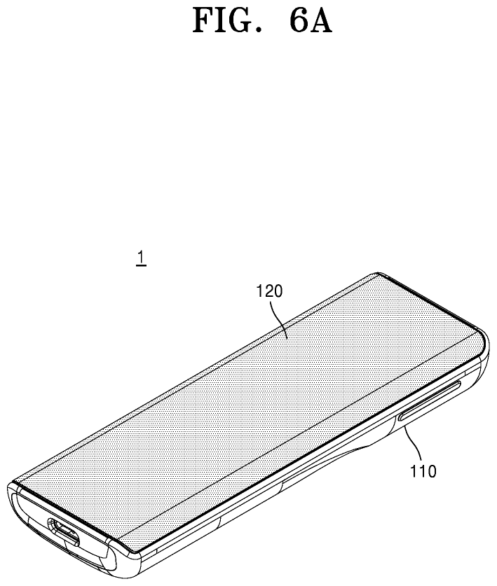

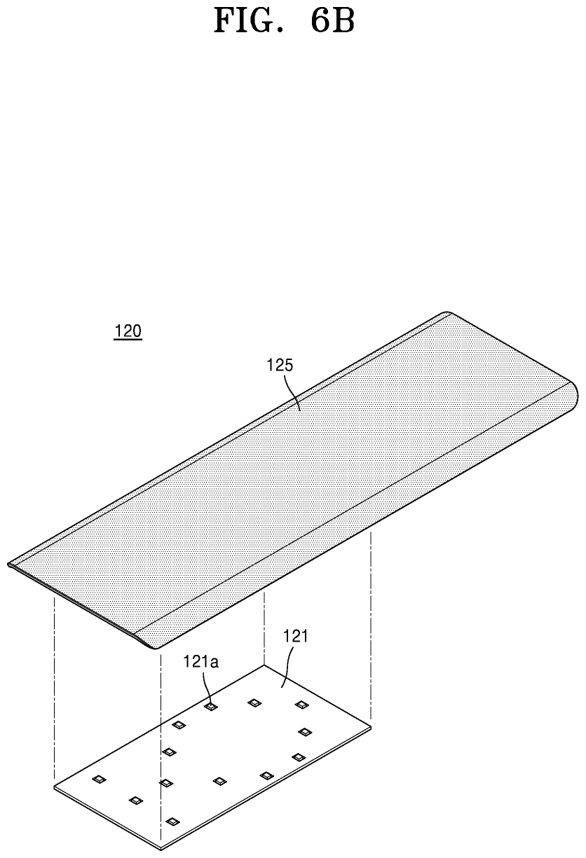

FIG. 6A is a view illustrating the external appearance of an aerosol generating device according to an embodiment.

Referring to FIG. 6A, an aerosol generating device 1 according to an embodiment may include a main body 110 and an outer cover 120 coupled to the main body 110.

The outer cover 120 may be coupled to a region of the main body 110 to protect components of the aerosol generating device 1, which are arranged on the main body 110. The main body 110 and the outer cover 120, which are coupled to each other, may form the overall external appearance of the aerosol generating device 1. The main body 110 and the outer cover 120 may be adhered to each other and undetachably coupled to each other, or may be detachably coupled to each other via a coupling means such as a coupling groove, but the coupling method may be variously implemented.

As will be described below, the components of the aerosol generating device 1 may be included in the main body 110, except for a circuit layer 121 which is included in the outer cover 120. For example, the main body 110 may have arranged therein an accommodation space into which a cigarette may be inserted, a heater for heating the cigarette, and a user interface (e.g., a universal serial bus (USB) interface) for electrically connecting the aerosol generating device 1 to an external device, but is not limited thereto.

FIG. 6B schematically illustrates a position at which a circuit layer 121 is attached to an outer cover of an aerosol generating device, according to an embodiment.

FIG. 6B illustrates only some components of an outer cover 120. The outer cover 120 includes the circuit layer 121, a base layer, a light-transmitting layer, a shielding layer, and a coating layer 125, which are sequentially arranged in a direction from a rear surface to a front surface of the outer cover 120, and one or more light-emitting units 121a arranged in the circuit layer 121. However, FIG. 6B omits components other than the circuit layer 121, the light-emitting units 121a, and the coating layer 125 to schematically illustrate a position at which the circuit layer 121 is attached to the outer cover 120.

Referring to FIG. 6B, the front surface of the outer cover 120 may include the coating layer 125, and the coating layer 125 may represent the external appearance of the outer cover 120. The coating layer 125 may represent a color of the front surface of the outer cover 120. In addition, the coating layer 125 may also represent the texture of the outer cover 120.

In an embodiment, the coating layer 125 may further include a hard coating layer for increasing the strength of the outer cover 120 and protecting the surface thereof. Here, the hard coating layer may include a transparent material so that the color of the coating layer 125 may appear on the front surface of the outer cover 120.

Referring to FIG. 6B, the circuit layer 121 may include one or more light-emitting units 121a. Light, which is emitted from the light-emitting units 121a, may be transmitted toward the front surface of the outer cover 120. The circuit layer 121 on which one or more light-emitting units 121a are disposed may be disposed on the rear surface of the outer cover 120. The circuit layer 121 may be adhered to the rear surface of the outer cover 120, and may be transferred onto the rear surface, but is not limited thereto.

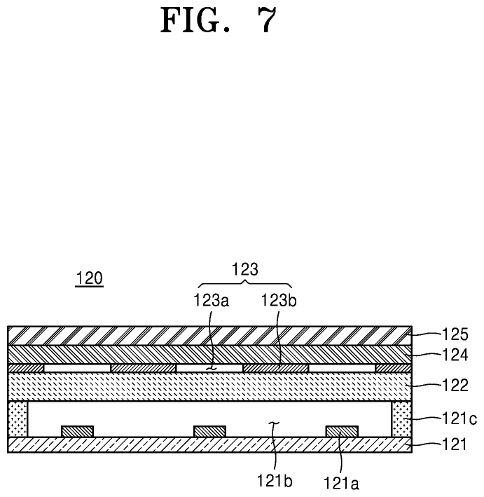

FIGS. 7 to 12 are schematic cross-sectional views of an outer cover of an aerosol generating device, according to an embodiment.

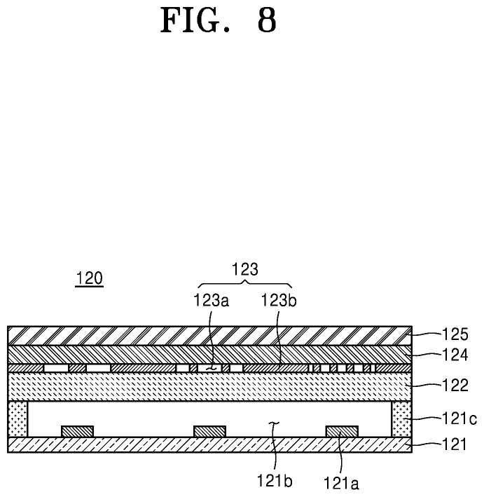

FIGS. 7 to 12 relate to various embodiments of the outer cover 120 of the aerosol generating device 1, and repeated descriptions thereof will be omitted. Various embodiments described below with reference to FIG. 7 may also be applied to FIGS. 8 to 12.

FIG. 7 illustrates a cross section of the outer cover 120 of the aerosol generating device 1, according to an embodiment.

The outer cover 120 of the aerosol generating device 1, according to an embodiment, may have a configuration in which light is emitted in a direction of a front surface of the outer cover 120. In other words, emitted light may be displayed on the front surface of the outer cover 120 so that a user may visually recognize the light emitted toward front surface of the outer cover 120.

In detail, the outer cover 120 may include a circuit layer 121, a base layer 122, a light-transmitting layer 123, a shielding layer 124, and a coating layer 125, which are sequentially arranged in a direction from a rear surface to the front surface of the outer cover 120.

The circuit layer 121 may include one or more light-emitting units 121a disposed on the circuit layer 121. The base layer 122, the light-transmitting layer 123, the shielding layer 124, and the coating layer 125 may include a material capable of transmitting light.

Light, which is emitted from the light-emitting units 121a disposed on the circuit layer 121, may sequentially pass through the base layer 122, the light-transmitting layer 123, the shielding layer 124, and the coating layer 125 and may be displayed on the front surface of the outer cover 120.

The outer cover 120 may include the circuit layer 121 including the light-emitting units 121a on the rear surface thereof, and thus a distance between a location where light is emitted and a location where the emitted light is displayed may be reduced. As a result, the non-uniformity of the light due to a positional deviation may also be reduced.

The base layer 122 may be disposed on the circuit layer 121, the light-transmitting layer 123 may be disposed on the base layer 122, the shielding layer 124 may be disposed on the light-transmitting layer 123, and the coating layer 125 may be disposed on the shielding layer 124. The coating layer 125 may constitute the front surface of the outer cover 120. In other words, the base layer 122, the light-transmitting layer 123, the shielding layer 124, and the coating layer 125 may be sequentially arranged in a direction of a front surface of the circuit layer 121 that matches the direction of the front surface of the outer cover 120.

The light-emitting units 121a may include a light source. The light source may be, for example, a light emitting diode (LED), but is not limited thereto, and may include another light source such as a lamp. The light-emitting units 121a may be arranged on a rear surface or the front surface of the circuit layer 121.

Light emitted from the light-emitting units 121a may be transmitted in the direction of the front surface of the outer cover 120. In detail, the light emitted from the light units 121a may sequentially pass through the base layer 122, the light-transmitting layer 123, the shielding layer 124, and the coating layer 125.

One or more light-emitting units 121a may be turned on or off to provide various types of information through the front surface of the outer cover 120. The light-emitting units 121a may also provide various types of information via a change in an intensity or color of light being emitted.

The light-emitting units 121a may display an operating state of the aerosol generating device 1 by emitting light in one of various predetermined colors. For example, a color of light emitted by the light-emitting units 121a may change with an increase in a temperature when the aerosol generating device 1 is preheated, and the change in color may be displayed on the front surface of the outer cover 120 to be visually recognized by a user. However, the disclosure is not limited thereto, and a notification may be output to a user in different manners according to embodiments. The operation of the light-emitting units 121a may be controlled by a controller (not shown).

The circuit layer 121 may be located on an outermost side of the rear surface of the outer cover 120, so the circuit layer 121 and the main body 110 may be in contact with each other when the main body 110 and the outer cover 120 are coupled to each other. Other components, such as a protective film, may be further included in the direction of the rear surface of the circuit layer 121 that matches the direction of the rear surface of the outer cover 120.

The circuit layer 121 may be a printed circuit board (PCB) or a flexible printed circuit board (FPCB), and the light-emitting units 121a may be mounted on the circuit layer 121. However, the arrangement form, installation method, or the like of the light-emitting units 121a is not limited. In addition, the circuit layer 121 may include at least one electrical connector (not shown) to be electrically connected to the light-emitting units 121a, the controller (not shown), and the like.

As an example, the base layer 122 may disposed on the circuit layer 121, and may be formed to be transparent or translucent to allow light to pass through. In other words, a display unit may include a material that transmits light with a certain transmittance. In detail, a translucent material may have a light transmittance that is greater than 0% and less than 100%.

In more detail, a material of the base layer 122 may include glass or a plastic material such as polyethylene terephthalate (PET), polymethyl methacrylate (PMMA), or polycarbonate (PC). However, the material of the base layer 122 is not limited thereto, and may also include other materials.

The base layer 122 may be a base for stacking the light-transmitting layer 123, the shielding layer 124, and the coating layer 125, and may provide rigidity of the outer cover 120.

As an example, a support unit 121c may be further included between the circuit layer 121 and the base layer 122 to solidify the arrangement between the circuit layer 121 and the base layer 122. The support unit 121c may be formed separately from the circuit layer 121 or the base layer 122, may be formed integrally with the circuit layer 121, or may be formed integrally with the base layer 122.

The support unit 121c may be arranged between the circuit layer 121 and the base layer 122, so that the light-emitting units 121a of the circuit layer 121 or other components (not shown) may not be in contact with the base layer 122. The support member 121c may be arranged on a portion of the circuit layer 121 where no components are disposed, and a space 121b may be formed between the circuit layer 121 and the base layer 122. Light emitted from the light-emitting units 121a may proceed toward the base layer 122 through the space 121b. In an embodiment, a surface of the support unit 121c facing the space 121b may have a characteristic of reflecting light.

As an example, the light-transmitting layer 123 may be disposed on the base layer 122. The light emitted from the light-emitting units 121a may pass through the base layer 122 and the light-transmitting layer 123. The light-transmitting layer 123 may include a material capable of transmitting light.

The light-transmitting layer 123 may include one or more light-transmitting units 123a capable of partially transmitting light and one or more light-blocking units 123b capable of partially blocking light. That is, the light-transmitting units 123a may have higher light transmittance than the light-blocking units 123b.

The light-transmitting units 123a may be formed at positions at which the light emitted from the light-emitting units 121a is transmitted.

For example, a plurality of light-emitting units 121a may be respectively formed at positions respectively corresponding to a plurality of light-transmitting units 123a, or a plurality of light-transmitting units 123a may be formed at a position corresponding to one light-emitting unit 121a. Alternatively, one light-transmitting unit 123a may be formed at a position corresponding to a plurality of light-emitting units 121a, and various combinations of the arrangements described above may be made.

In addition, the path of light emitted from the light-emitting units 121a may be adjusted via reflection, refraction, or the like, and one or more light-transmitting units 123a may be arranged on the adjusted path of light.

The light-transmitting layer 123 may be printed and formed on the base layer 122 by a printing process such as silk-screening, or by another transfer process.

The light-blocking units 123b may block the light emitted from the light-emitting units 121a, and may be printed by using a colored ink. The ink may be a black or other colored ink. The color of the ink may be the same as or similar to the color of the shielding layer 124 or the coating layer 125.

The light-transmitting units 123a may transmit the light emitted from the light-emitting units 121a, and may be the remaining portion of the light-transmitting layer 123 in which the light-blocking units 123b are not formed. The light-transmitting units 123a may be formed at positions corresponding to the light-emitting units 121a. Thus, when the light-emitting units 121 emit light, the light-transmitting units 123a may transmit the light to expose the light to the outside.

The light-transmitting units 123a may be the remaining regions other than the light-blocking units 123b. The light-transmitting units 123a may be a hole, or may be formed of a material capable of transmitting light. The light-blocking units 123b may be formed by printing a material blocking light, and the light-transmitting units 123a may be formed in regions in which the material blocking light is not printed so that the light-blocking units 123b have a hole described above. A material capable of transmitting light may be, for example, a urethane-based resin.

Each of the light-transmitting units 123a may have various sizes and shapes, for example, may have a circular or polygonal shape.

The light-transmitting units 123a may transmit the light emitted from the light-emitting units 121a and expose the light to the front surface of the outer cover 120 so that the user may observe the light. In detail, the light emitted from the light-emitting units 121a may pass sequentially through the base layer 122, the light-transmitting units 123a of the light-transmitting layer 123, the shielding layer 124, and the coating layer 125, to be observed by the user.

By turning on or off the one or more light-emitting units 121a, a plurality of light-transmitting units 123a may display a picture, number, character, or the like on the front surface of the outer cover 120.

As an example, the shielding layer 124 may be disposed on the light-transmitting layer 123. When the light-emitting units 121a are turned off, the light-transmitting units 123a may be concealed by the shielding layer 124 so that the light-transmitting units 123a for light transmission may not be visible through the front surface of the outer cover 120.

The shielding layer 124 may transmit the light emitted from the light-emitting units 121a toward the front surface of the outer cover 120 when the light-emitting units 121a are turned on, and may conceal the light-transmitting units 123a so it is not visible through the front surface of the outer cover 120 when the light-emitting units 121a are turned off. In other words, the shielding layer 124 may transmit the light emitted from the light-emitting units 121a to the outside (i.e., in the direction of the front surface) and prevent light incident from the outside from being transmitted to the inside (i.e., in the direction of the rear surface).

Due to the shielding layer 124, the user may not recognize an internal structure or the like of the emitting units 121a or the light-transmitting units 123a that transmit the light emitted from the light-emitting units 121a, and may recognize only light transmitted from the light-emitting units 121a to the front surface of the outer cover 120. According to the implementation, a design may be aesthetically enhanced.

The shielding layer 124 may be in the form of a very thin metal layer. For example, the shielding layer 124 may be formed by printing a metallic ink or by coating with a semi-transmissive spray. However, the shielding layer 124 is not limited thereto, and may be implemented by another material capable of adjusting a transmittance.

As an example, the coating layer 125 may be disposed on the shielding layer 124. The coating layer 125 may form the external appearance of the front surface of the outer cover 120 of the aerosol generating device 1. A color, texture, and the like of the front surface of the outer cover 120 may be formed by the coating layer 125. The coating layer 125 may be formed, for example, by film transfer.

The coating layer 125 may include a material capable of transmitting light. The light emitted from the light-emitting units 121a may be sequentially transmitted through the base layer 122, the light-transmitting layer 123, the shielding layer 124, and the coating layer 125, and may be displayed on the front surface of the outer cover 120. The front surface of the outer cover 120 may be a front surface of the coating layer 125.

As an example, the coating layer 125 may additionally include a hard coating layer having high hardness to enhance the surface hardness and durability of the front surface of the outer cover 120.

FIG. 8 illustrates a cross section of an outer cover 120 of the aerosol generating device 1, according to another embodiment.

A circuit layer 121, a light-emitting unit 121a, a base layer 122, a light-transmitting layer 123, a shielding layer 124, a coating layer 125, and the like illustrated in FIG. 8 are the same as the components described above with reference to FIG. 7, and thus, descriptions thereof are omitted.

As described above, the light transmitting layer 123 may include one or more light-transmitting units 123a capable of transmitting light and one or more light-blocking units 123b capable of blocking light. The light-transmitting units 123a may be formed at positions at which light emitted from the light-emitting unit 121a is transmitted.

Referring to FIG. 8, a plurality of light-transmitting units 123a may be formed at positions at which light emitted from one light-emitting unit 121a is transmitted.

As shown in FIG. 8, assuming that a path of light emitted from one light-emitting unit 121a does not overlap a path of light emitted from another light-emitting unit 121a, the light emitted from the one light-emitting unit 121a may be arranged to pass through two light-transmitting units 123a, the light emitted from another light-emitting unit 121a may be arranged to pass through three light-transmitting units 123a, and the light emitted from the another light-emitting unit 121a may be arranged to pass through five light-transmitting units 123a.

The number, arrangement interval, size, and the like of the light-transmitting units 123a may be variously set. At least one shape from among a picture, a character, a number, and a symbol may be formed by appropriately setting the number, arrangement interval, size, and of the light-transmitting units 123a. In other words, the light-transmitting unit 123a may transmit light emitted from at least one of the light-emitting units 121a, and the light transmitted through the light-transmitting unit 123a may reach a front surface of the outer cover 120, and thus, a user may recognize at least one shape from among a picture, a character, a number, and a symbol.

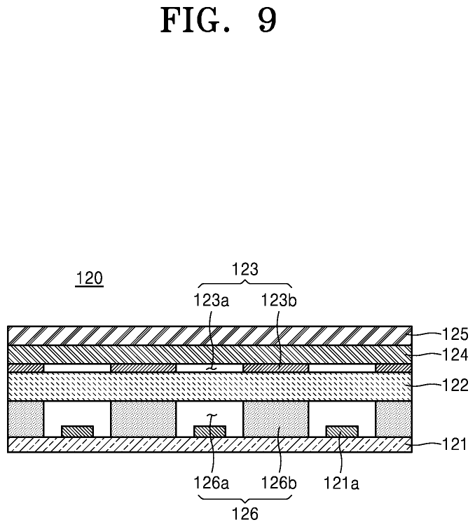

FIG. 9 illustrates a cross section of an outer cover 120 of the aerosol generating device 1, according to another embodiment.

Referring to FIG. 9, unlike the embodiments of FIGS. 7 and 8, a light diffusion layer 126 arranged between a circuit layer 121 and a base layer 122 may be included. A circuit layer 121, a light-emitting unit 121a, the base layer 122, a light-transmitting layer 123, a shielding layer 124, a coating layer 125, and the like are the same as the components described above, and thus, descriptions thereof are omitted.

The light diffusion layer 126 may be arranged between the circuit layer 121 and the base layer 122, and may guide light emitted from the light-emitting unit 121a to pass through a light-transmitting unit 123a. The light diffusion layer 126 may include one or more light guide units 126a and one or more light reflection units 126b.

The light guide units 126a may transmit light emitted from the light-emitting unit 121a, and the light reflection units 126b may reflect light emitted from the light-emitting unit 121a. The light guide units 126a and the light reflection units 126b may be included to allow light to be concentrated toward the light-transmitting unit 123a of the light-transmitting layer 123. Accordingly, relatively bright light may be displayed even with a small amount of light, and relatively little power may be used for light emission from the light-emitting unit 121a.

The light reflection units 126b may be formed of a material that reflects light. In an embodiment, only a portion of the light reflection units 126b, which are in contact with the light guide units 126a, may include a material that reflects light. When only a portion of the light reflection units 126b include a material that reflects light, the remaining portions of the light reflection units 126b may be filled with a material that does not transmit light, to allow the light emitted from the light-emitting unit 121a to pass through only the light guide units 126a.

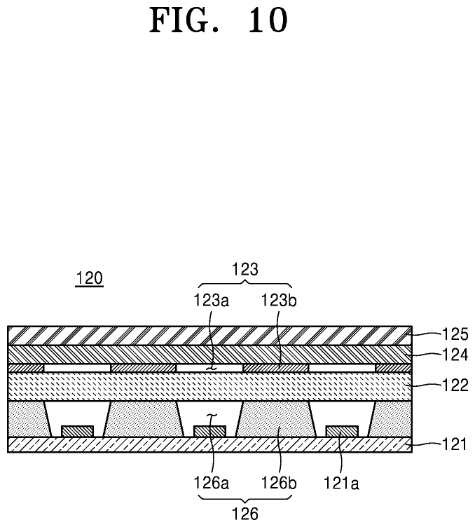

FIG. 10 illustrates a cross section of an outer cover 120 of the aerosol generating device 1, according to another embodiment.

Referring to FIG. 10, a light guide unit 126a may have a shape that gradually increases in size from a circuit layer 121 toward a base layer 122. This shape may allow light to be further concentrated in a direction of a light-transmitting unit 123a of a light-transmitting layer 123. When the light guide unit 126a has the shape as illustrated in FIG. 10, a light reflection unit 126b may have a shape which gradually decreases in size from the circuit layer 121 toward the base layer 122. However, embodiments are not limited to the above shape and may include any shape for achieving the goals described above.

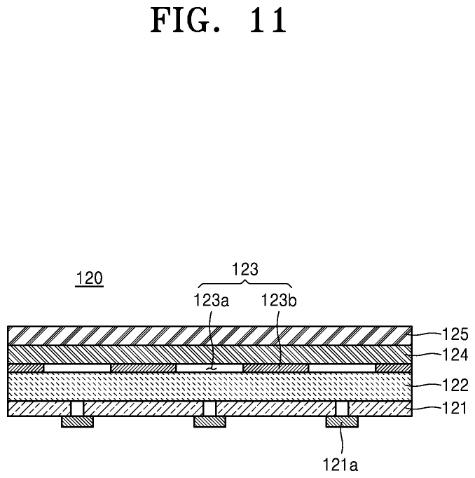

FIG. 11 illustrates a cross section of an outer cover 120 of the aerosol generating device 1, according to another embodiment.

Referring to FIG. 11, unlike the embodiments of FIGS. 7 to 10, a light-emitting unit 121a may be arranged on a rear surface of a circuit layer 121. A circuit layer 121, a light-emitting unit 121a, the base layer 122, a light-transmitting layer 123, a shielding layer 124, a coating layer 125, and the like are the same as the components described above, and thus, descriptions thereof are omitted.

Light emitted from the light-emitting unit 121a arranged on the rear surface of the circuit layer 121 may pass through the base layer 122, the light-transmitting layer 123, the shielding layer 124, and the coating layer 125, and may be displayed on a front surface of the outer cover 120.

As illustrated in FIG. 11, when the light-emitting unit 121a is arranged on the rear surface of the circuit layer 121, an arrangement interval between the circuit layer 121 and the base layer 122 may be reduced, and thus, a positional deviation due to tolerance may be reduced. In other words, a distance between a location where light is emitted and a location where the emitted light is displayed may be reduced, and thus, the non-uniformity of the light due to the positional deviation may be reduced.

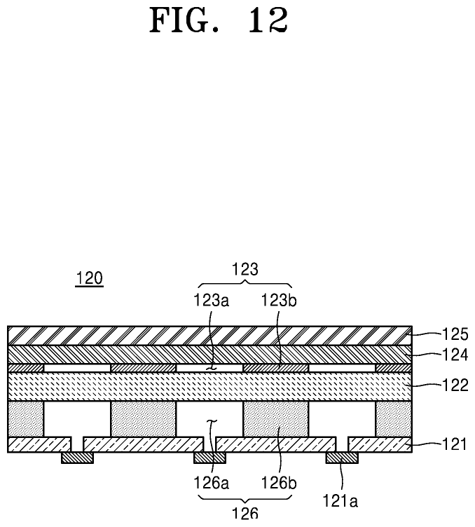

FIG. 12 illustrates a cross section of an outer cover 120 of the aerosol generating device 1, according to another embodiment.

Referring to FIG. 12, similar to the embodiment of FIG. 11, a light-emitting unit 121a may be arranged on a rear surface of a circuit layer 121. However, unlike the embodiment of FIG. 11, a light diffusion layer 126 arranged between a circuit layer 121 and a base layer 122 may be included. A circuit layer 121, the light-emitting unit 121a, the base layer 122, a light-transmitting layer 123, a shielding layer 124, a coating layer 125, and the like are the same as the components described above, and thus, descriptions thereof are omitted.

The light diffusion layer 126 may be arranged between the circuit layer 121 and the base layer 122, and may guide light emitted from the light-emitting unit 121a to pass through a light-transmitting unit 123a. The light diffusion layer 126 may include one or more light guide units 126a and one or more light reflection units 126b.

The light guide units 126a may transmit light emitted from the light-emitting unit 121a, and the light reflection units 126b may reflect light emitted from the light-emitting unit 121a. The light guide units 126a and the light reflection units 126b may be included to allow light to be concentrated in a direction of the light-transmitting unit 123a of the light-transmitting layer 123. Accordingly, relatively bright light may be displayed even with a small amount of light, and relatively little power may be used for light emission from the light-emitting unit 121a.

When the light guide units 126a concentrates light in the direction of the light-transmitting unit 123a, the number or shape of the light guide units 126a is not limited.

The outer cover 120 for the aerosol generating device 1, according to the embodiments described above, may be manufactured by: providing a base layer 122; sequentially stacking a light-transmitting layer 123, a shielding layer 124, and a coating layer 125 on a front surface of the base layer 122; and arranging, on a rear surface of the base layer 122, a circuit layer 121 on which one or more light-emitting units 121a are arranged. As described above, the base layer 122, the light-transmitting layer 123, the shielding layer 124, and the coating layer 125 may include a material capable of transmitting light, and light emitted from the light-emitting unit 121a may sequentially pass through the base layer 122, the light-transmitting layer 123, the shielding layer 124, and the coating layer 125.

Also, as described above, the light-transmitting layer 123 may include one or more light-transmitting units 123a transmitting light and one or more light-blocking units 123b blocking light. Here, the light-blocking units 123b may be formed by printing a material blocking light, and the light-transmitting units 123 a may be formed in regions in which the material blocking light is not printed, but the light-blocking units 123b and the light-transmitting units 123a are not limited to the above methods.

In addition, the operation of arranging the circuit layer 121 on the rear surface of the base layer 122 may include an operation of adhering the circuit layer 121 to the rear surface of the base layer 122 or forming the circuit layer 121 on the rear surface of the base layer 122.

In detail, the adhering may be performed by using a general adhering method in the art, for example, by using an adhesive or an adhesive tape, or via a fusion method. The circuit layer 121 may be arranged on the rear surface of the base layer 122 by directly transferring the circuit layer 121 onto the rear surface of the base layer 122, but embodiments are not limited thereto.

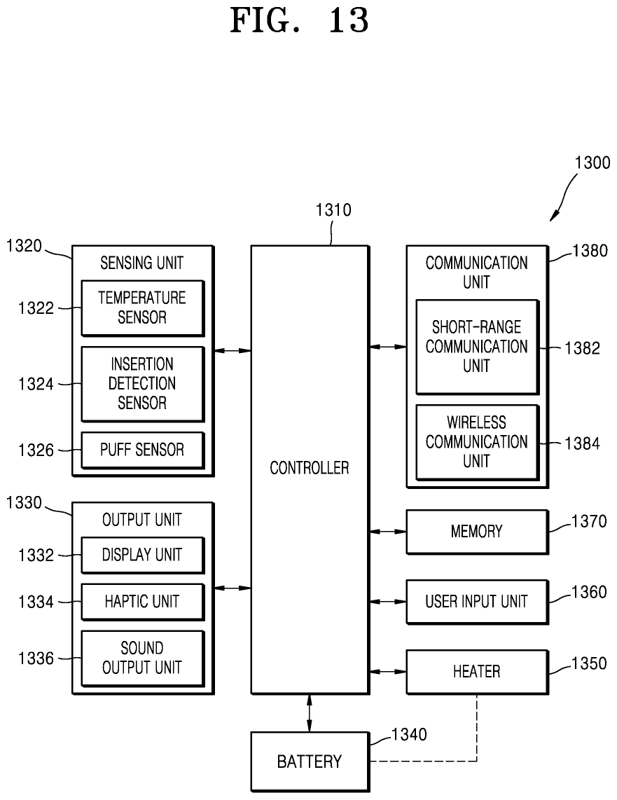

FIG. 13 is a block diagram of an aerosol generating device 1300 according to another embodiment.

The aerosol generating device 1300 may include a controller 1310, a sensing unit 1320, an output unit 1330, a battery 1340, a heater 1350, a user input unit 1360, a memory 1370, and a communication unit 1380. However, the internal structure of the aerosol generating device 1300 is not limited to those illustrated in FIG. 13. That is, according to the design of the aerosol generating device 1300, it will be understood by one of ordinary skill in the art that some of the components shown in FIG. 13 may be omitted or new components may be added.

The sensing unit 1320 may sense a state of the aerosol generating device 1300 and a state around the aerosol generating device 1300, and transmit sensed information to the controller 1310. Based on the sensed information, the controller 1310 may control the aerosol generating device 1300 to perform various functions, such as controlling an operation of the heater 1350, limiting smoking, determining whether an aerosol generating article (e.g., a cigarette, a cartridge, or the like) is inserted, displaying a notification, or the like.

The sensing unit 1320 may include at least one of a temperature sensor 1322, an insertion detection sensor, and a puff sensor 1326, but is not limited thereto.

The temperature sensor 1322 may sense a temperature at which the heater 1350 (or an aerosol generating material) is heated. The aerosol generating device 1300 may include a separate temperature sensor for sensing the temperature of the heater 1350, or the beater 1350 may serve as a temperature sensor. Alternatively, the temperature sensor 1322 may also be arranged around the battery 1340 to monitor the temperature of the battery 1340.

The insertion detection sensor 1324 may sense insertion and/or removal of an aerosol generating article. For example, the insertion detection sensor 1324 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1326 may sense a user's puff on the basis of various physical changes in an airflow passage or an airflow channel. For example, the puff sensor 1326 may sense a user's puff on the basis of any one of a temperature change, a flow change, a voltage change, and a pressure change.

The sensing unit 1320 may include, in addition to the temperature sensor 1322, the insertion detection sensor 1324, and the puff sensor 1326 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1330 may output information on a state of the aerosol generating device 1300 and provide the information to a user. The output unit 1330 may include at least one of a display unit 1332, a haptic unit 1334, and a sound output unit 1336, but is not limited thereto. When the display unit 1332 and a touch pad form a layered structure to form a touch screen, the display unit 1332 may also be used as an input device in addition to an output device.

The display unit 1332 may visually provide information about the aerosol generating device 1300 to the user. For example, information about the aerosol generating device 1300 may mean various pieces of information, such as a charging/discharging state of the battery 1340 of the aerosol generating device 1300, a preheating state of the heater 1350, an insertion/removal state of an aerosol generating article, or a state in which the use of the aerosol generating device 1300 is restricted (e.g., sensing of an abnormal object), or the like, and the display unit 1332 may output the information to the outside. The display unit 1332 may be, for example, a liquid crystal display panel (LCD), an organic light-emitting diode (OLED) display panel, or the like. In addition, the display unit 1332 may be in the form of a light-emitting diode (LED) light-emitting device.

The haptic unit 1334 may tactilely provide information about the aerosol generating device 1300 to the user by converting an electrical signal into a mechanical stimulus or an electrical stimulus. For example, the haptic unit 1334 may include a motor, a piezo-electric element, or an electrical stimulation device.

The sound output unit 1336 may audibly provide information about the aerosol generating device 1300 to the user. For example, the sound output unit 1336 may convert an electrical signal into a sound signal and output the same to the outside.

The battery 1340 may supply power used to operate the aerosol generating device 1300. The battery 1340 may supply power such that the heater 1350 may be heated. In addition, the battery 1340 may supply power required for operations of other components (e.g., the sensing unit 1320, the output unit 1330, the user input unit 1360, the memory 1370, and the communication unit 1380) in the aerosol generating device 1300. The battery 1340 may be a rechargeable battery or a disposable battery. For example, the battery 1340 may be a lithium polymer (LiPoly) battery, but is not limited thereto.

The heater 1350 may receive power from the battery 1340 to heat an aerosol generating material. Although not illustrated in FIG. 13, the aerosol generating device 1300 may further include a power conversion circuit (e.g., a direct current (DC)/DC converter) that converts power of the battery 1340 and supplies the same to the heater 1350. In addition, when the aerosol generating device 1300 generates aerosols in an induction heating method, the aerosol generating device 1300 may further include a DC/alternating current (AC) that converts DC power of the battery 1340 into AC power.

The controller 1310, the sensing unit 1320, the output unit 1330, the user input unit 1360, the memory 1370, and the communication unit 1380 may each receive power from the battery 1340 to perform a function. Although not illustrated in FIG. 13, the aerosol generating device 1300 may further include a power conversion circuit that converts power of the battery 1340 to supply the power to respective components, for example, a low dropout (LDO) circuit, or a voltage regulator circuit.

In an embodiment, the heater 1350 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1350 may be implemented by a metal wire, a metal plate on which an electrically conductive track is arranged, a ceramic heating element, or the like, but is not limited thereto.

In another embodiment, the heater 1350 may be a heater of an induction heating type. For example, the heater 1350 may include a suspector that heats an aerosol generating material by generating heat through a magnetic field applied by a coil.

The user input unit 1360 may receive information input from the user or may output information to the user. For example, the user input unit 1360 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 13, the aerosol generating device 1300 may further include a connection interface, such as a universal serial bus (USB) interface, and may connect to other external devices through the connection interface, such as the USB interface, to transmit and receive information, or to charge the battery 1340.

The memory 1370 is a hardware component that stores various types of data processed in the aerosol generating device 1300, and may store data processed and data to be processed by the controller 1310. The memory 1370 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1370 may store an operation time of the aerosol generating device 1300, the maximum number of puffs, the current number of puffs, at least one temperature profile, data on a user's smoking pattern, etc.

The communication unit 1380 may include at least one component for communication with another electronic device. For example, the communication unit 1380 may include a short-range wireless communication unit 1382 and a wireless communication unit 1384.

The short-range wireless communication unit 1382 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1384 may include a cellular network communication unit, an Internet communication unit, a computer network (e.g., local area network (LAN) or wide area network (WAN)) communication unit, or the like, but is not limited thereto. The wireless communication unit 1384 may also identify and authenticate the aerosol generating device 1300 within a communication network by using subscriber information (e.g., International Mobile Subscriber Identifier (IMSI)).

The controller 1310 may control general operations of the aerosol generating device 1300. In an embodiment, the controller 1310 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1310 may control the temperature of the heater 1350 by controlling supply of power of the battery 1340 to the heater 1350. For example, the controller 1310 may control power supply by controlling switching of a switching element between the battery 1340 and the heater 1350. In another example, a direct heating circuit may also control power supply to the heater 1350 according to a control command of the controller 1310.

The controller 1310 may analyze a result sensed by the sensing unit 1320 and control subsequent processes to be performed. For example, the controller 1310 may control power supplied to the heater 1350 to start or end an operation of the heater 1350 on the basis of a result sensed by the sensing unit 1320. As another example, the controller 1310 may control, based on a result sensed by the sensing unit 1320, an amount of power supplied to the beater 1350 and the time the power is supplied, such that the heater 1350 may be heated to a certain temperature or maintained at an appropriate temperature.

The controller 1310 may control the output unit 1330 on the basis of a result sensed by the sensing unit 1320. For example, when the number of puffs counted through the puff sensor 1326 reaches a preset number, the controller 1310 may notify the user that the aerosol generating device 1300 will soon be terminated through at least one of the display unit 1332, the haptic unit 1334, and the sound output unit 1336.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media. The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a main body; and
an outer cover coupled to the main body,
wherein the outer cover includes a circuit layer, a base layer, a light-transmitting layer, a shielding layer, and a coating layer, which are sequentially arranged in a direction from a rear surface of the outer cover toward a front surface of the outer cover, and one or more light-emitting units arranged on the circuit layer,
wherein the base layer, the light-transmitting layer, the shielding layer, and the coating layer include a material capable of transmitting light, and
wherein light emitted from the light-emitting units sequentially passes through the base layer, the light-transmitting layer, the shielding layer, and the coating layer.

2. The aerosol generating device of claim 1, wherein
the light-transmitting layer includes:
one or more light-transmitting units configured to transmit light; and
one or more light-blocking units configured to block light,
the light-transmitting units are formed at positions at which light emitted from the light-emitting units is transmitted, and
the light emitted from the light-emitting units sequentially passes through the base layer, the light-transmitting units, the shielding layer, and the coating layer.

3. The aerosol generating device of claim 2, further comprising a light diffusion layer arranged between the circuit layer and the base layer and configured to guide the light emitted from the light light-emitting units toward the light-transmitting units.

4. The aerosol generating device of claim 3, wherein the light diffusion layer includes:
one or more light guide units configured to transmit the light emitted from the light-emitting units; and
one or more light reflection units configured to reflect the light emitted from the light-emitting units.

5. The aerosol generating device of claim 4, wherein the light guide units have a shape which gradually increases in size from the circuit layer toward the base layer.

6. The aerosol generating device of claim 2, wherein the shielding layer is configured to transmit the light emitted from the light-emitting units toward the front surface of the outer cover when the light-emitting units are turned on, and to prevent the light-transmitting units from being visible through the front surface of the outer cover when the light-emitting units are turned off.

7. The aerosol generating device of claim 2, wherein the one or more light-transmitting units are configured to form at least one shape from among a picture, a character, a number, and a symbol by the light emitted from the light-emitting units.

8. The aerosol generating device of claim 1, wherein the light-emitting unit are arranged on a rear surface or a front surface of the circuit layer.

9. The aerosol generating device of claim 1, wherein the coating layer is configured to exhibit a color of the front surface of the outer cover.

10. A method of manufacturing an outer cover for an aerosol generating device, the method comprising:
providing a base layer;
sequentially stacking a light-transmitting layer, a shielding layer, and a coating layer, on a front surface of the base layer; and
arranging, on a rear surface of the base layer, a circuit layer on which one or more light-emitting units are arranged,
wherein the base layer, the light-transmitting layer, the shielding layer, and the coating layer include a material capable of transmitting light, and light emitted from the light-emitting units sequentially passes through the base layer, the light-transmitting layer, the shielding layer, and the coating layer.

11. The method of claim 10, wherein the light-transmitting layer includes one or more light-transmitting units configured to transmit light and one or more light-blocking units configured to block light, and the light-transmitting units are formed at positions at which the light emitted from the light-emitting units is transmitted.

12. The method of claim 11, wherein the light-blocking units are formed by printing a material that blocks light, and the light-transmitting units are formed in regions in which the material that blocks light is not printed.

13. The method of claim 10, wherein the arranging of the circuit layer includes adhering the circuit layer to the rear surface of the base layer or forming the circuit layer on the rear surface of the base layer.
